(19) United States
(12) Patent Application Publication
(10) Pub. No.: US 2022/0222759 A1
(43) Pub. Date: Jul. 14, 2022

(54) REAL-TIME LOCATION-AWARE COMMUNICATION SYSTEM

(71) Applicant: NEWHOUSE, INC., Smyrna, GA (US)

(72) Inventors: GEMEZ MARSHALL, SMYRNA, GA (US); BRANDEIS MARSHALL, SMYRNA, GA (US)

(21) Appl. No.: 17/543,413

(22) Filed: Dec. 6, 2021

Related U.S. Application Data
(63) Continuation-in-part of application No. 15/285,975, filed on Oct. 5, 2016, now abandoned.
(60) Provisional application No. 62/237,023, filed on Oct. 5, 2015.

(51) Int. Cl. G06Q 50/16; G06Q 30/06; H04W 4/029; H04W 4/021

(52) U.S. Cl. CPC G06Q 50/16; H04W 4/021; H04W 4/029; G06Q 30/0631

(57) ABSTRACT

Disclosed are various embodiments for a real-time location-aware communication system. In one embodiment, the system detects a completion of a predefined action via a mobile device. The predefined action includes at least one of: an interaction with an electronic user interface corresponding to an electronic listing of a location for an interaction threshold, an addition of the electronic listing to a watchlist via the electronic user interface, a sharing action with respect to the electronic listing with one or more other users via an electronic network, or an automatic detection via a location-finding subsystem of the mobile device that the mobile device has physically visited the location based at least in part on a periodic reporting of a location of the mobile device by the location-finding subsystem via a network and determining whether the location of the mobile device matches a geofence of the location.

### BACKGROUND

Communication involving transactions facilitated at least partially electronically using computer hardware has traditionally involved the services of first party agents and second party agents, who may not have associated computer hardware. First party agents are tasked with preparing a location to be listed for availability. Second party agents, by contrast, represent particular potential second parties and move from location to location while providing recommendations.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a schematic block diagram of a networked environment according to various embodiments of the present disclosure.

FIGS. 2A-2G are pictorial diagrams of example user interfaces rendered by a client in the networked environment of FIG. 1 according to various embodiments of the present disclosure.

FIGS. 3A-3D are flowcharts illustrating examples of functionality implemented as portions of a listing platform service executed in a computing environment in the networked environment of FIG. 1 according to various embodiments of the present disclosure.

FIG. 4 is a schematic block diagram that provides one example illustration of a computing environment employed in the networked environment of FIG. 1 according to various embodiments of the present disclosure.

### DETAILED DESCRIPTION

The present disclosure relates to a real-time, location-aware communication system. Although electronic listing platforms exist, at present they are little more than searching and browsing platforms for potential second parties to discover targets of interest. All transactions and communications are handled manually, out-of-band through interactions with agents.

With the present system of first party and second party agents, there are great impediments to developing a system that facilitates communication for transactions purely electronically and on an automated basis, like a site like EBAY does with respect to the sale of goods. Any electronic system must have the support of agents in order to be successful. If agents' interests are not protected, there is little incentive for their participation. Without their participation, such a system would not achieve a critical mass of listings to be successful or useful to potential second parties.

Various embodiments of the present disclosure introduce a new real-time location-aware communication system for use in conjunction with a listing platform. In an embodiment, first parties are able to receive real-time notifications that computing devices of potential second parties are currently visiting their locations or that potential second parties are meeting a threshold for engagement with their electronic listings. However, in order to protect the agent system, the communications are anonymized with respect to the second parties, and the second parties are identified by their agents. At the same time, more detailed information can be shared with computing devices corresponding to the second party agents and/or other agents on their electronic team. Further, in recognition that a second party often involves a “team” (e.g., husband and wife, roommates, business partners, etc.), more detailed information can be shared with other individuals on the second party's team. In some cases, information can be made available publicly to other potential second parties.

Likewise, computing devices of potential second parties are able to receive real-time notifications from the first party or the first party's agent. For example, a computing device of a first party team may send a notification to a computing device of a second party team during their showing and entice them to submit a responsive communication. In order to protect the first party's identity, the notification will present the information of the first party's agent in lieu of personally identifying information of the first party.

In addition to providing notifications, various embodiments facilitate initiating transactions online. For example, a second party may tender a responsive communication for a location online, and a first party can accept the responsive communication or tender a subsequent responsive communication, also online. The communications relative to the transactions can be mediated or moderated by the respective second party and first party agents electronically. Further, information about the fact of a responsive communication may be made publicly viewable to other potential second parties in order to stimulate competitive interest. Additionally, competitive interest can be enticed by sending notifications related to other actions (e.g., listings being watched, showings being scheduled) prior to a responsive communication being submitted. Such notifications may, for example, be sent to competing second parties, their agents, and related team members.

In various embodiments, social network integrations may be provided to assist potential second parties and potential first parties with the discovery of agents that their friends on the social network may be using. Various facts, such as a location becoming unavailable or having a transaction consummated, may be published to friends, along with identifications of corresponding agents. In the following discussion, a general description of the system and its components is provided, followed by a discussion of the operation of the same.

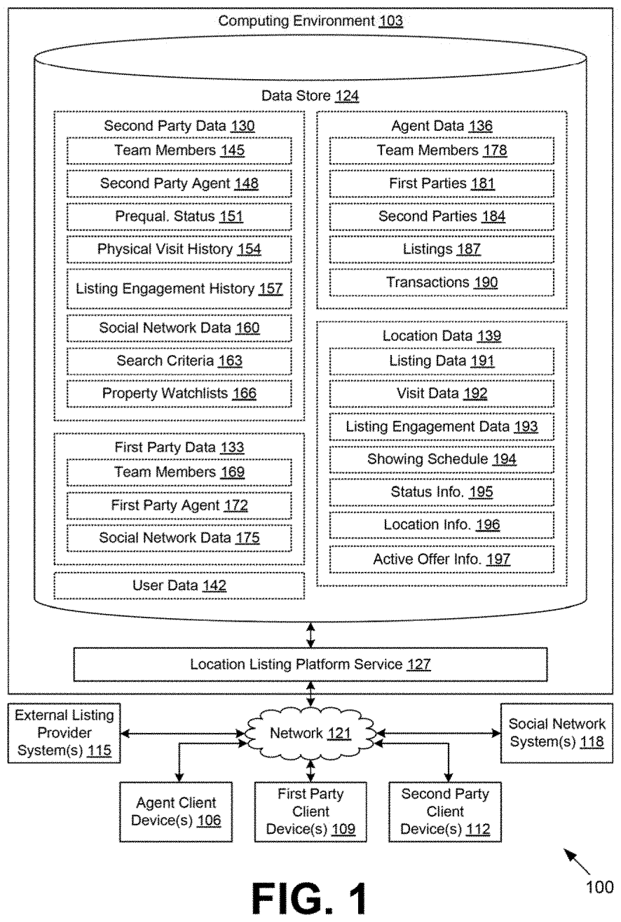

With reference to FIG. 1, shown is a networked environment 100 according to various embodiments. The networked environment 100 includes a computing environment 103, one or more agent client devices 106, one or more second party client devices 109, one or more first party client devices 112, one or more external listing provider systems 115, and one or more social network systems 118, which are in data communication with each other via a network 121. The network 121 includes, for example, the Internet, intranets, extranets, wide area networks (WANs), local area networks (LANs), wired networks, wireless networks, cable networks, satellite networks, or other suitable networks, etc., or any combination of two or more such networks.

The computing environment 103 may comprise, for example, a server computer or any other system providing computing capability. Alternatively, the computing environment 103 may employ a plurality of computing devices that may be arranged, for example, in one or more server banks or computer banks or other arrangements. Such computing devices may be located in a single installation or may be distributed among many different geographical locations. For example, the computing environment 103 may include a plurality of computing devices that together may comprise a hosted computing resource, a grid computing resource, and/or any other distributed computing arrangement. In some cases, the computing environment 103 may correspond to an elastic computing resource where the allotted capacity of processing, network, storage, or other computing-related resources may vary over time.

Various applications and/or other functionality may be executed in the computing environment 103 according to various embodiments. Also, various data is stored in a data store 124 that is accessible to the computing environment 103. The data store 124 may be representative of a plurality of data stores 124 as can be appreciated. The data stored in the data store 124, for example, is associated with the operation of the various applications and/or functional entities described below. Non-limiting examples of commercially available technologies used in the data store 124 may include APACHE CASSANDRA (or other relational database management system), APACHE SOLR (or other search engine), APACHE KAFKA (or other queue platform), and others.

The components executed on the computing environment 103, for example, include a location listing platform service 127 and other applications, services, processes, systems, engines, or functionality not discussed in detail herein. The location listing platform service 127 is executed to provide functionality involving real-time communications and transactions, search, browse, and other activities with respect to location listings as will be described. Although the location listing platform service 127 is described herein as a single service, the location listing platform service 127 may be structured as multiple different applications, processes, services, systems, engines, or modules in various implementations. In one specific implementation, the location listing platform service 127 is implemented in part using a RUBY-ON-RAILS application server, along with APACHE STORM to process streaming data in real-time.

The data stored in the data store 124 includes, for example, second party data 130, first party data 133, agent data 136, location data 139, user data 142, and potentially other data. To begin, the second party data 130 includes a variety of data about users of the system who happen to be second parties, potential second parties, lessees, or potential lessees of locations. Included within the second party data 130 may be data regarding team members 145, a second party agent 148, a prequalification status 151, a physical visit history 154, a listing engagement history 157, social network data 160, search criteria 163, location watchlists 166, and/or other data.

The team members 145 may identify various users who are considered members of the second party's team, so to speak. This recognizes that second parties may include husband and wife teams, partnerships, and other associations among multiple people. Associated with the team members 145 may be various parameters that give permissions or restrict functionality with respect to particular team members. In some cases, all team members 145 may have equal permissions, while in other cases, one or more team members 145 may be restricted. For example, a person may shop for a location along with his friend, who is giving advice. Although the person may wish for his friend to be included on all communications, the friend should not be given permission to bind the person with respect to transactions. By contrast, with a joint venture, affirmative permission from all team members 145 may be required to enter into a transaction.

A second party may be associated with one or more second party agents 148. In some cases, a second party may enter into an exclusive representation agreement with a particular second party agent 148. In other cases, the second party may utilize multiple second party agents 148, where each second party agent 148 has rights to transactions with respect to particular locations. In some cases, a second party may be unrepresented by an agent and may work with the listing agent of a location directly.

A second party may be associated with a prequalification status 151, which may be an amount for which the second party is approved or preapproved. The prequalification status 151 may indicate a maximum amount that the second party can afford, considering a down payment and the second party's documented income. The prequalification status 151 may be associated with several restrictions, such as only Federal Housing Association (FHA)-approved locations can be considered, or that the locations must meet flood plain criteria, etc. The prequalification status 151 may be used to preclude second parties from tendering responsive communications on locations for which they are not prequalified, and/or to inform first parties in an automated way that the second parties are prequalified for their locations.

The physical visit history 154 may track various information about a second party's visit to one or more locations. For example, the second party client device 109 may include a location-finding subsystem (e.g., a global positioning system (GPS) device, cellular triangulation, wireless access point triangulation, etc.) that tracks when the second party is at a listed location. The physical visit history 154 may record dates and times of a second party's visit, length of the second party's visit, the second party's route around the location, and other information, which may be used to gauge the second party's level of interest in the location, and in the aggregate, the level of second party interest across multiple potential second parties.

Similarly, the listing engagement history 157 may track various information about a second party's engagement with an electronic listing. For example, the listing engagement history 157 may record the length of time that a listing user interface has been visible upon a display of a second party client device 109, how many images from the listing have been viewed or clicked through by the client device, dates and times of the engagements as well as frequency, any hovering over user interface elements related to the listing, any copying of images or text related to the listing via the computer device, whether the second party shared the listing with computing device of other users via the location listing platform service 127 or via social network, whether other users have viewed the listing after referral by the second party (e.g., token identifier embedded in uniform resource locator (URL) shared with others), and/or other information.

The social network data 160 includes information about social network platforms linked to the second party that the second party has elected to share. This information may include contact information for other users within a circle of friends.

The search criteria 163 include stored and/or otherwise entered criteria supplied by second parties in their search for listings via the location listing platform service 127. The search criteria 163 may include, for example, whether there is an active responsive communication and criteria related to the active responsive communication (e.g., value, responsive communication deadline), whether a listing is watched by a potential second party, minimum price, maximum price, geographic area criteria (e.g., ZIP code, city and state), number of bedrooms, number of bathrooms, average utility bills, whether a specified utility is available (e.g., natural gas, fiber broadband), year constructed, type of location (e.g., single family detached, condominium, townhome, vacant land, mobile home), living area, type of garage or carport, number of kitchens, whether a pool is available, whether a fireplace is available, whether tennis courts are available, homeowner's association fees, siding type or other construction parameters, roof age, sewer or septic availability, and/or other criteria.

The location watchlists 166 are lists of locations that have been selected as favorites by the second party or one or more team members. The locations may be manually selected for inclusion on the location watchlist 166, or the locations may be automatically selected by matching search criteria 163 or by virtue of a level of engagement seen in the listing engagement history 157 or through a visit recorded in the physical visit history 154. When on a location watchlist 166, various changes in status of a location or a competing user's engagement relative to a location (e.g., making a responsive communication, scheduling a showing, etc.) may be published as notifications to the second party and associated team members.

The first party data 133 includes a variety of data about users of the system who happen to be first parties or lessors of locations (generally, “offerors” of locations). The first party data 133 may include, for example, data related to team members 169, a first party agent 172, social network data 175, and/or other data. Like second parties, first parties may be associated with multiple team members 169, who may be co-owners or simply persons associated with or interested in helping the first party. The first party agent 172 corresponds to a listing agent for one or more locations that the first parties is offering. The social network data 175 includes information about social network platforms linked to the first party that the first party has elected to share. This information may include contact information for other users within a circle of friends.

The agent data 136 includes a variety of data about users of the system who are agents. These agents may be listing agents for some locations, while representing second parties for other locations. Included within the agent data 136 may be data related, for example, to team members 178, second parties 181, first parties 184, listings 187, transactions 190, and/or other data. Like the second parties and first parties, the agents may be associated with one or more other users who are team members 178. For example, a busy agent may have a team with multiple other agents and/or support staff that assist the agent. In some cases, the team members 178 may correspond to all members of a particular agent office.

A given agent may represent one or more second parties 181 seeking to purchase and/or lease location and/or one or more first parties 184 seeking to sell or lease out location. Further, an agent may have one or more listings 187 of locations. These listings 187 may be involved in one or more current transactions 190, including a sale transaction or a lease transaction. In some cases, a listing 187 may have multiple transactions 190, including backup transactions 190 such as backup responsive communications that will automatically proceed if a prior transaction 190 is not consummated.

The location data 139 includes data relating to locations listed and/or previously listed via the location listing platform service 127. Such locations may include houses, multiplexes, apartments, condominiums, townhouses, mobile homes, vacant land, farms, commercial locations, and so on. The locations may be fee simple interests, life estates, remainder interests, leaseholds, usufructs, timeshares, and/or other types. Included in the location data 139, for example, includes listing data 191, visit data 192, listing engagement data 193, a showing schedule 194, status information 195, location information 196, active responsive communication information 197, and/or other data.

The listing data 191 includes a variety of data in a listing that can be presented via a user interface. This data can include, for example, photographs, video tours, audio tours, asking price, title, description, address, square feet/area, numbers of bedrooms and bathrooms, whether a pool is present, location taxes, previous sales information, previous valuations, and/or other information. Portions of the listing data 191 may be viewable only by agents, first parties, and/or second parties, as well as team members 145, 169, 178.

The visit data 192 may track numbers of second parties' computing device and potentially their identities who have visited the location, either during a showing or during an informal visit. The visit data 192 may include lengths of the visit and portions of the location visited. For example, the visit data 192 may indicate that three second parties visited the location, but stayed only five minutes on average and left after seeing the kitchen. The listing engagement data 193 may track numbers of second parties and potentially their identities who have viewed or interacted with the electronic listing, including types of interactions and lengths. For example, the listing engagement data 193 may indicate that 256 second parties have visited the electronic listing, that the average time interacting with the listing was two minutes, and that ten second parties in particular (with their identities) added the location to their location watchlists 166 or met other threshold criteria for engagement.

The showing schedule 194 may give a calendar of showing availabilities. The showing schedule 194 may indicate when the location is available and/or is unavailable. The status information 195 indicates a current status of the location, which could include, for example, newly listed, listing updated, open house scheduled, under contract, contingent, available, and so on. The location information 196 may include coordinates of the location. In some cases, the location information 196 may include locations of particular rooms or a geofence of the location or the rooms. Thus, using the location information 196, it can be determine whether a user has entered the location, left the location, entered a specific area of the location, exited a specific area of the location, and so on.

The active responsive communication information 197 includes various information about responsive communications to purchase or lease the location that may be active or pending. Such responsive communications may be accepted by the first party, pending acceptance or rejection by the first party, or rejected by the first party. The responsive communications may be associated with deadlines for acceptance. The fact of a pending active responsive communication and its associated deadlines may be published to users of the system, including competing second parties. However, in one embodiment, the competing second parties are not made aware of the value of the pending active responsive communication in order to stimulate completive interest, even if, for example, the value of the pending active responsive communication is unreasonably low.

The user data 142 includes various information about users of the system, which may include second parties 181, first parties 184, agents, or team members 145, 169, 178. The users may be registered or unregistered. Activities of the users may be tracked via explicit login or implicitly via cookies. The user data 142 may include profile and contact information (e.g., name, address, email address, phone number, fax number, etc.), security credentials such as usernames and passwords, and/or other data.

The agent client devices 106, the second party client devices 109, and the first party client devices 112 are representative of a plurality of client devices that may be coupled to the network 121. The agent client devices 106, the second party client devices 109, and the first party client devices 112 may comprise, for example, a processor-based system such as a computer system. Such a computer system may be embodied in the form of a desktop computer, a laptop computer, personal digital assistants, cellular telephones, smartphones, set-top boxes, music players, web pads, tablet computer systems, game consoles, electronic book readers, smartwatches, head mounted displays, voice interface devices, or other devices. The agent client devices 106, the second party client devices 109, and the first party client devices 112 may include a display comprising, for example, one or more devices such as liquid crystal display (LCD) displays, gas plasma-based flat panel displays, organic light emitting diode (OLED) displays, electrophoretic ink (E ink) displays, LCD projectors, or other types of display devices, etc.

The agent client devices 106, the second party client devices 109, and the first party client devices 112 may be configured to execute various applications such as a client application and/or other applications. The client application may be executed in the agent client devices 106, the second party client devices 109, and the first party client devices 112, for example, to access network content served up by the computing environment 103 and/or other servers, thereby rendering a user interface on the display. To this end, the client application may comprise, for example, a browser, a dedicated application, etc., and the user interface may comprise a network page, an application screen, etc. The agent client devices 106, the second party client devices 109, and the first party client devices 112 may be configured to execute applications beyond the client application such as, for example, web services, email applications, social networking applications, word processors, spreadsheets, and/or other applications.

The external listing provider systems 115 and the social network systems 118 may comprise, for example, a server computer or any other system providing computing capability. Alternatively, the external listing provider systems 115 and the social network systems 118 may employ a plurality of computing devices that may be arranged, for example, in one or more server banks or computer banks or other arrangements. Such computing devices may be located in a single installation or may be distributed among many different geographical locations. For example, the external listing provider systems 115 and the social network systems 118 may include a plurality of computing devices that together may comprise a hosted computing resource, a grid computing resource, and/or any other distributed computing arrangement. In some cases, the external listing provider systems 115 and the social network systems 118 may correspond to an elastic computing resource where the allotted capacity of processing, network, storage, or other computing-related resources may vary over time.

The external listing provider systems 115 are configured to provide listing data 191 from an external provider, such as a Multiple Listing Service (MLS). For example, the external listing provider systems 115 may provide periodic data feeds with updated information from the listing data 191. Although the listing data 191 may be created via the location listing platform service 127, integration with the external listing provider systems 115 enables the use of existing legacy systems that provide listing data 191.

The social network systems 118 are configured to provide access to social network services for social network integrations. The social network systems 118 may facilitate obtaining profile information from users, use of a federated identity login, obtaining lists of friends for a user, publishing items to a user's data feed, sharing items with friends of a user, and/or other activities.

Next, a general description of the operation of the various components of the networked environment 100 is provided. To begin, listing data 191 is on-boarded onto the system, potentially via a data feed from an external listing provider system 115. Users are able to create user accounts, and relationships among users and locations are designated. For instance, upon registration, listing agents and first parties are able to claim listings in the listing data 191 with which they are associated. Users can also indicate team members 145, 169, 178 with whom they are sharing information and/or rights. The team members 145, 169, 178 may be existing users or may be designated through a medium of communication by which they can be on-boarded at a later time.

Potential second parties may begin interacting with the location listing platform service 127 through a series of network pages and/or a dedicated client application. For example, a second party user may use a second party client device 109 to execute a location listing search or to access a URL for a specific listing. The user may search by entering various search criteria 163, which may include specific addresses or location finding via a map. Ultimately, the user is able to see information from a location listing (i.e., the listing data 191) in a user interface. To see certain information or to perform certain activities, the user may be asked to register as a second party and create an account via the location listing platform service 127.

Upon creating an account via the location listing platform service 127, the second party's activities can be tracked in the physical visit history 154, the listing engagement history 157, the search criteria 163, and the location watchlists 166. In some cases, the previous activities associated with the second party client device 109 via a tracking cookie may also be on-boarded to the account. The user can also define a relationship with one or more second party agents 148 with respect to one or more locations.

Also, as the second party interacts with an electronic listing, various real-time notifications can be automatically generated by the location listing platform service 127. These notifications may include email messages, phone calls, text messages, notifications via a web page, and so forth.

To begin with, real-time notifications can be sent to the first party, the first party's agent, and/or the team members 178 of the first party's agent for the location, such as a property. Such a notification may excite the first party and indicate that potential second parties are interested enough in the electronic listing to interact with it. For privacy concerns, these notifications will not include (or will mask) the potential second party's identifying information. While masking or anonymizing the potential second party's identifying information, an identification of the second party agent 148 may be included. In addition to addressing privacy concerns, this prevents direct communication between second parties and first parties that could result in transactions happening outside the control of the agents involved.

These notifications may include non-identifying characteristics of the potential second party, such as, for example, other locations visited by or with listings viewed by the second party, search criteria 163 used by the second party to arrive at the listing, prequalification status 151, other locations on the location watchlist 166 of the second party, browsing habits of the second party, and so on. The notifications can also include specifics as to the particular engagement with the electronic listing such as, for example, time spent viewing the electronic listing, time spent viewing specific items of the electronic listing, repeat visits, whether items or the listing were shared with others via a social network or other team members 145, whether photographs were viewed, and so on. In some cases, these notifications may be triggered upon the second party interacting with the particular listing and meeting a predefined threshold for sufficient engagement, e.g., explicitly adding the location to a location watchlist 166, spending more than five minutes viewing the listing, viewing the listing more than once via a bookmark (i.e., no referring URL found), and so forth.

In one embodiment, the location listing platform service 127 may enable an anonymized communication between the second party and the first party, first party's agent, and/or team members 178 such that the second party can ask questions and receive answers. This communication may be moderated via the second party's agent and/or team members 178 of the second party's agent in some scenarios.

Next, notifications in this situation may also be sent to the second party's agent, team members 178 of the second party's agent, and/or team members 145 of the second party. Unlike the notifications to the first party, first party's agent, and/or team members 178 of the first party's agent, these notifications will include an identification of the second party. This enables the team members 178 of the second party's agent, and/or team members 145 of the second party to follow up with the second party to answer any questions. Along with automatically generated notifications upon meeting a threshold for engagement, the location listing platform service 127 may allow communication between a second party and the second party's agent, team members 178 of the second party's agent, and/or team members 145 of the second party in order to ask questions or to note the listing for future references.

Similarly, real-time notifications can be sent to competing second parties, the competing second party's agent, and/or the team members 178 of the competing second party's agent for the location. Such a notification may warn the competing second party and indicate that a potential second party is interested enough in the listing to interact with it on their second party client device 109 or visit the location. For privacy concerns, these notifications may not include (or may mask) the potential second party's identifying information. While masking or anonymizing the potential second party's identifying information, an identification of the second party agent 148 may be included.

The location listing platform service 127 also can facilitate scheduling showings for second parties of locations. While vacant locations can be seen at nearly anytime depending on the second party's and second party agent's schedules, scheduling showings of occupied locations has typically been a challenge. The location listing platform service 127 as described facilitates automating the scheduling of showings on the basis of a calendar provided by first party, potentially a calendar provided by a first party's agent, along with an intersection of the second party's agent's calendar. In this way, a showing schedule 194 can be generated.

A user interface generated by the location listing platform service 127 can show open times. Also, the user interface can suggest times to potential second parties that are adjacent to times at which showings are already scheduled by other potential second parties. This consolidates the showing times to simplify the times at which the first party is expected not to be at the location or otherwise to make the location available for showings.

In addition to scheduled showings, second parties may sometimes visit a location unannounced or attended by a second party's agent. If not attended, the second parties may still walk the location to observe it. The location listing platform service 127 is configured to track these physical visits to the location via the physical visit history 154. For example, the location listing platform service 127 may receive a location of the second party from a client application executed by the second party client device 109. This location may be generated automatically via a location-finding subsystem of the second party client device 109. When the location is within the location of a location as recorded in the location information 196, the location listing platform service 127 is able to record that the second party has entered the location. Where specific geofences or boundaries of rooms or other features of the location, the location listing platform service 127 may record entrances and exits relative to these features. The location listing platform service 127 may also record a path taken by the second party and the second party client device 109 as the location is traversed. When the second party exits, that fact may also be recorded.

In addition to recording the facts relating to the visit in the physical visit history 154, the location listing platform service 127 may also initiate notifications to other users relative to the physical location visit. Real-time notifications can be sent to the first party, the first party's agent, and/or the team members 178 of the first party's agent for the location. Such a notification may excite the first party and indicate that potential second parties are interested enough to physically visit the location. For privacy concerns, these notifications will not include (or will mask) the potential second party's identifying information. While masking or anonymizing the potential second party's identifying information, an identification of the second party agent 148 may be included. In addition to addressing privacy concerns, this prevents direct communication between second parties and first parties that could result in transactions happening outside the control of the agents involved.

These notifications may include non-identifying characteristics of the potential second party, such as, for example, other locations visited by or with listings viewed by the second party, search criteria 163 used by the second party to arrive at the listing, prequalification status 151, other locations on the location watchlist 166 of the second party, browsing habits of the second party, and so on. The notifications can also include specifics as to the physical visit such as, for example, time spent visiting the location, time spent in particular areas of the location, a path taken by the second party in traversing the location, and so on. In some cases, notifications may be sent to competing buying teams, including competing second parties, competing second party agents, team members of 145 of competing second parties, and team members 178 of competing second party agents. Similarly, the identity of the second party who caused the notification is masked and replaced with an identification of the second party's agent.

Notifications in this situation may also be sent to the second party's agent, team members 178 of the second party's agent, and/or team members 145 of the second party. Unlike the notifications to the first party, first party's agent, and/or team members 178 of the first party's agent, these notifications will include an identification of the second party. This enables the team members 178 of the second party's agent, and/or team members 145 of the second party to follow up with the second party to answer any questions. Along with automatically generated notifications upon a physical visit, the location listing platform service 127 may allow communication between a second party and the second party's agent, team members 178 of the second party's agent, and/or team members 145 of the second party in order to ask questions or to note the location for future references.

The location listing platform service 127 is also configured to facilitate transactions relative to locations, such as a second party tendering a responsive communication, a first party accepting the offer, a first party tendering a counteroffer, a second party accepting a counteroffer, contact modifications in response to inspections, appraisals, or financing contingencies, and so forth. Such contracts created herein can be for the purchase or lease of location.

When a notification of a second party's offer is sent to the first party, the first party's agent, and/or the team members 178 of the first party's agent, the notification may include the prequalification status 151 of the second party in order to vouch for or otherwise support the second party's offer. In some cases, the location listing platform service 127 may be configured to prevent second parties from placing responsive communications when they are not appropriately prequalified. For instance, if a second party wishes to place a responsive communication for a house for a designated amount, the location listing platform service 127 may be configured to verify that the second party is prequalified in the prequalification status 151 for at least a designated amount purchase. Like other notifications, offer notifications may be configured to mask the identity of the second party and include only an identification of the second party's agent.

Responsive communications can be sent in real-time to first party client devices 112 and to agent client devices 106, and the first party is able to accept the responsive communication, or counter, electronically via a user interface. Accepting or countering may involve replying to a text message, clicking a button labeled “accept” or “counter,” replying to a speech interface using a voice command, and/or other actions. The responsive communications as presented may be associated with a deadline for acceptance. In some scenarios, the deadline may expire and the location listing platform service 127 can facilitate extension of the responsive communication deadline. The offer deadline may be published as a notification to other parties such as other second parties, their agents, and any team members. If changed, the change of the responsive communication deadline may also be published to these interested parties.

The status information 195 can be updated in real-time regarding the status of the location transaction. The fact of a pending offer may result in published real-time notifications to one or more second parties for whom the location has been added to a location watchlist 166 or otherwise who have expressed at least a threshold level of interest in the location. When the fact of a pending offer is made known, potential second parties who are “on the fence” may be motivated to submit competing responsive communications at the same time. This may result in higher or better responsive communications than otherwise would be made.

The notifications described herein as performed by the location listing platform service 127 may be made via a social network system 118 in some embodiments. In integrating with a social network system 118, the location listing platform service 127 may publish publicly or to a circle of friends that a first party or first party's agent has listed a location, that a second party has visited a location, that a first party, a second party, second party's agent, or first party's agent has an executed contract for a location, that a first party, a second party, second party's agent, or first party's agent has closed a sale or lease transaction for a location, and so forth. Such notifications may be performed automatically or upon manual confirmation by a user. The notifications may include links in order for users to view the electronic listing via the location listing platform service 127 and/or to learn more information about a first party's agent or second party's agent involved in the transaction (e.g., via the agent's web page or social network profile).

The location listing platform service 127 may generate various user interfaces that indicate agent performance and track record. Various statistics about agents may include days a listing was on the market, asking price, sales price, closings, and so forth.

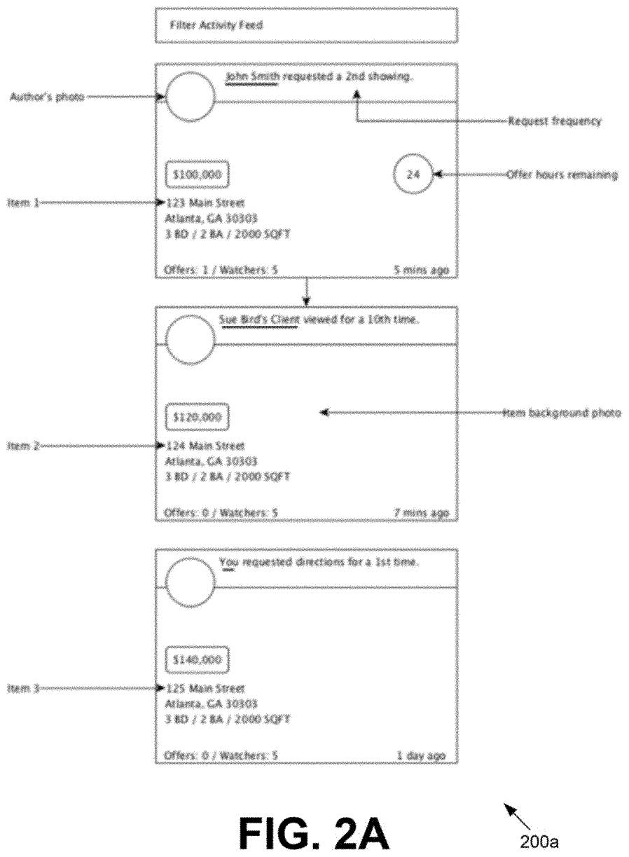

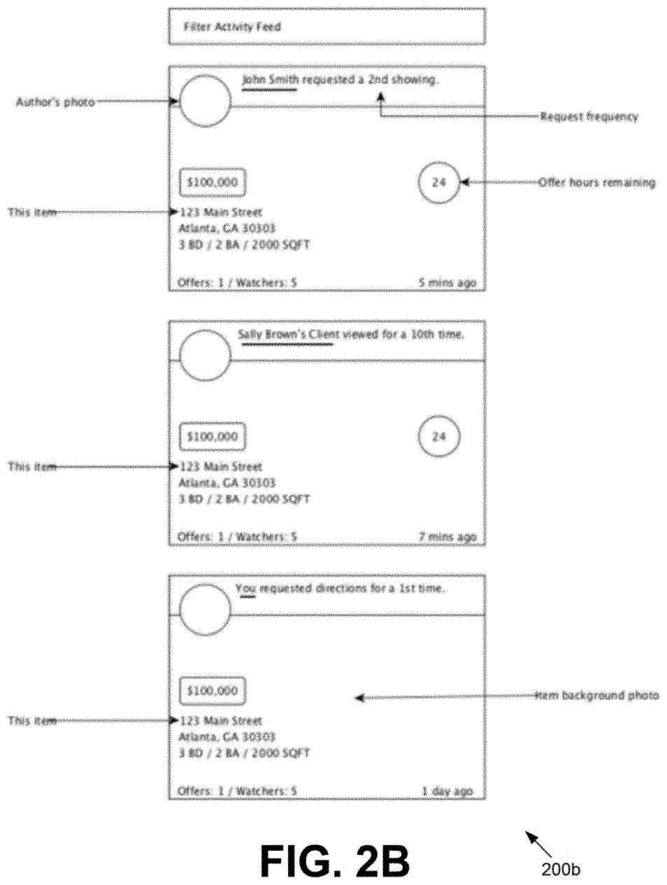

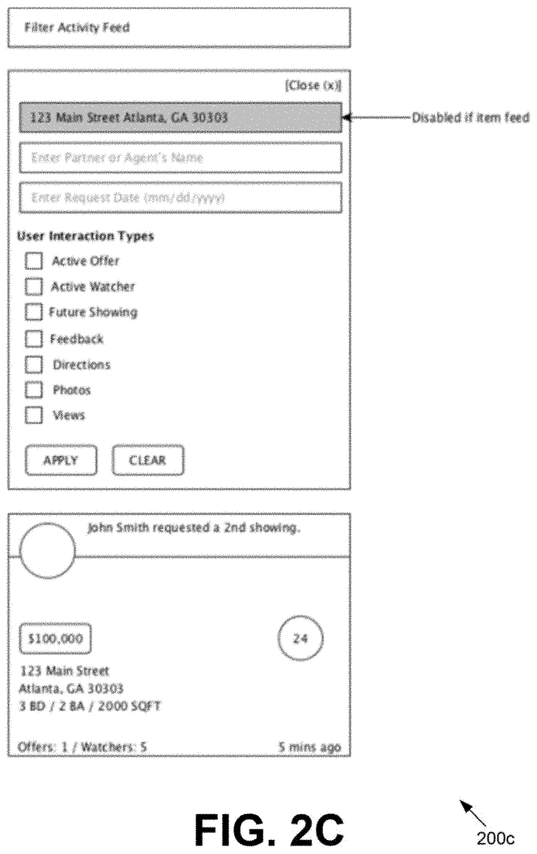

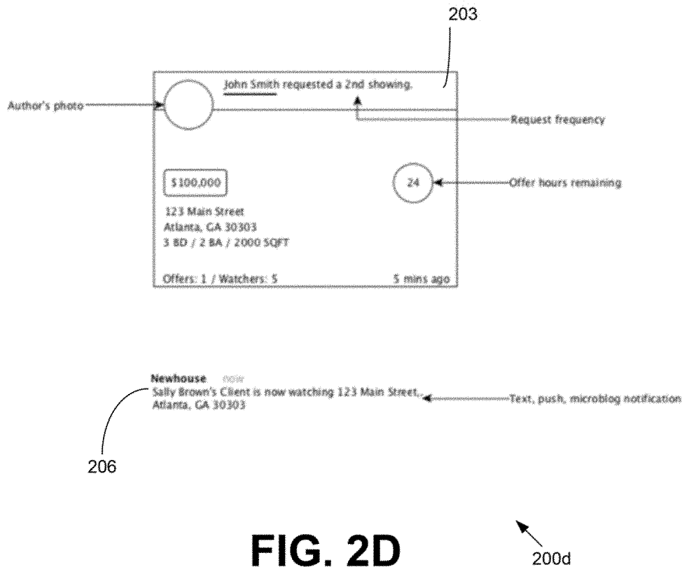

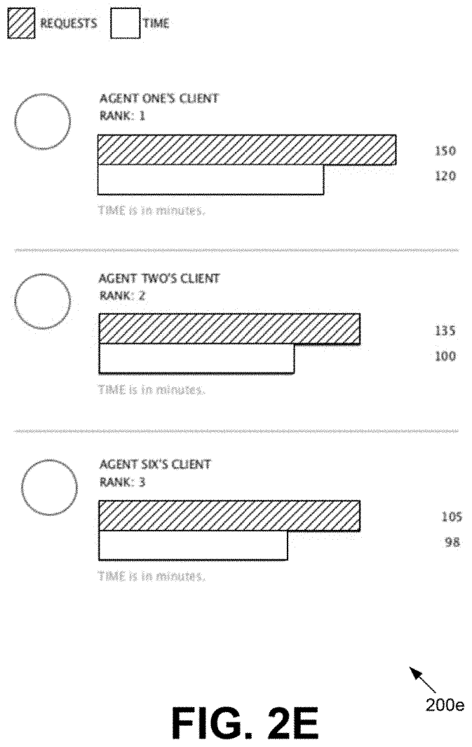

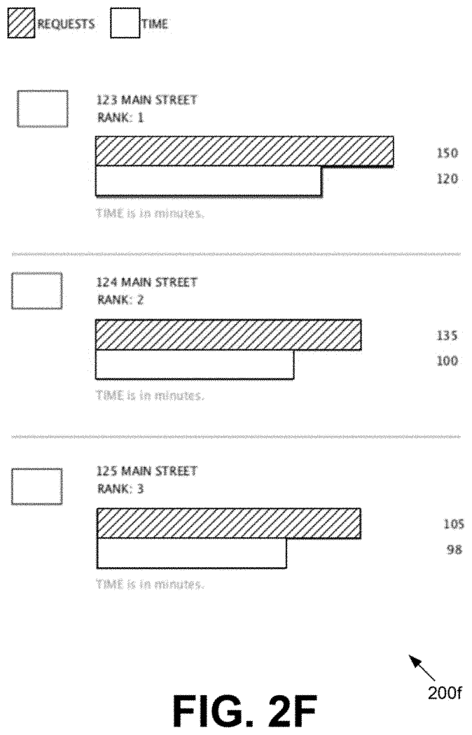

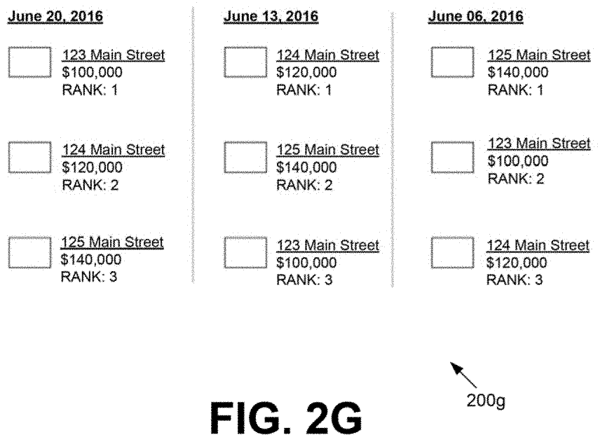

Referring now to FIG. 2A, shown is an example user interface 200a of an activity feed of a user. Each user can have one or more personal feeds to receive location notifications. For example, a potential second party may be searching in a new city, state, or school district. Simultaneously, the user can have feed to track the activity on the house they are selling. Likewise, listing agents have feeds to watch potential second parties. Second party agents have feeds to see which locations interest their clients. As shown, the activity feed can include notifications that a user has requested a showing with a request frequency, a user has viewed a listing a number of times, that to the location has been requested by the current user for a number of times, among other information. FIG. 2B shows a similar example user interface 200b of an activity feed specific to a location listing.

FIG. 2C shows an example filtering user interface 200c for activity feeds of a user. For personal feeds, activities can be limited by location, user, request date, or interaction type. Interaction types can include active responsive communications, active watchers, future showings, feedback, directions, photos, and views.

FIG. 2D shows example user interfaces 200d for notifications. Email notifications 203 may resemble feed entries. Text, push, and microblog notifications 206 may include the actionable portion of the activity.

FIG. 2E shows an example user interface 200e that presents trends respect to potential second parties, where the second party's identities are hidden and only the identity of the second party's agent is shown. In order to promote some degree of competition interest, second parties are ranked by interest levels. Interaction time and number of online requests may be interest factors, among others.

FIG. 2F shows an example user interface 200f that presents trends respect to locations. Each location that a user interacts with gets ranked to identify their level of interest. This could be useful for a second party's agent and partner. It could also show first parties and listing agents how their location compares to the potential second party's favorites.

FIG. 2G shows an example user interface 200g that presents comparable trends respect to locations. For locations within a given category, a user may want to see how they compare on a weekly basis. Categories can include product type, color, location, and more.

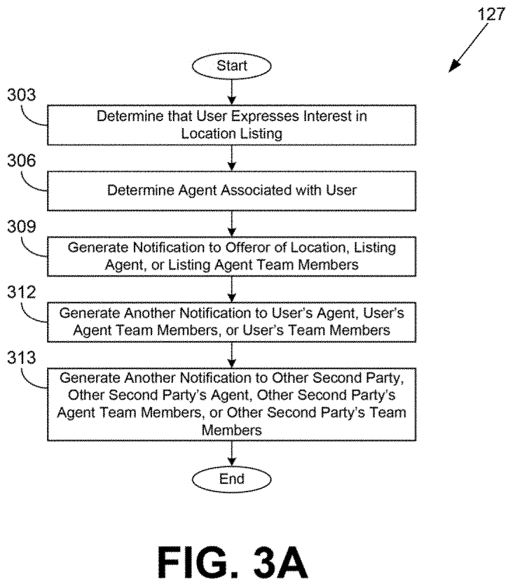

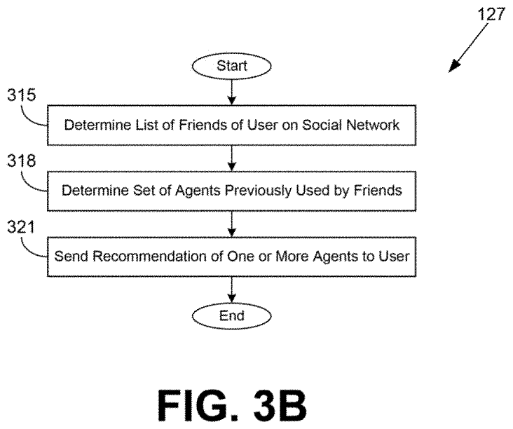

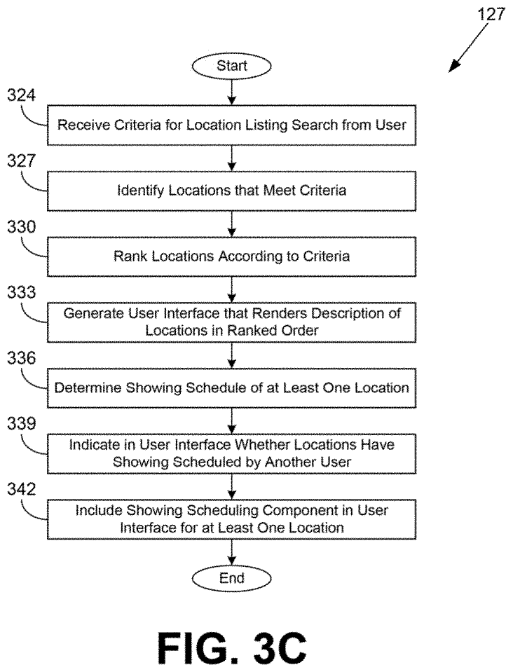

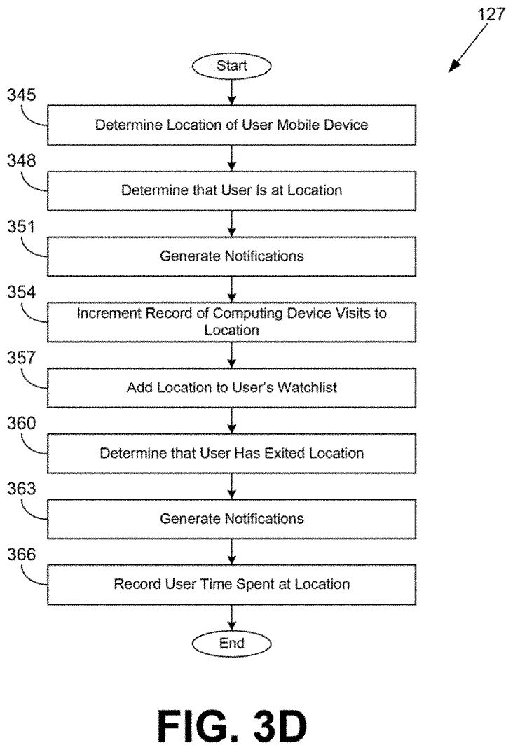

Referring next to FIG. 3A, shown is a flowchart that provides one example of the operation of a portion of the location listing platform service 127 according to various embodiments. It is understood that the flowchart of FIG. 3A provides merely an example of the many different types of functional arrangements that may be employed to implement the operation of the portion of the location listing platform service 127 as described herein. As an alternative, the flowchart of FIG. 3A may be viewed as depicting an example of elements of a method implemented in the computing environment 103 (FIG. 1) according to one or more embodiments.

Beginning with box 303, the location listing platform service 127 determines that a user, such as a potential second party or lessee, expresses an interest in a location listing. For example, the user may interact with an electronic user interface corresponding to an electronic listing such that the interaction meets a threshold. To illustrate, if the listing has 25 photographs, and the user views at least 12 of them, that may be sufficient to express an interest. In some cases, the user may perform an action such as adding the location to a location watchlist 166 or sharing the listing via a social network system 118 which may express an interest. Alternatively, if the user engages with the listing for at least a threshold time (e.g., five minutes) or a time relative to that of other users with respect to the listing, that may be sufficient to express an interest. As another alternative, if the user physically visits the location, that may be sufficient to express an interest in the location.

In box 306, the location listing platform service 127 determines an agent associated with the user, such as a second party agent 148. However, in some cases, the user may be unrepresented.

In box 309, the location listing platform service 127 may generate one or more notifications to the offeror of the location (e.g., the first party or lessor), one or more team members 169 of the offeror of the location, a listing agent, and/or one or more team members 178 of the listing agent. These notifications include an identification of the second party agent 148 or indicate that the second party is unrepresented. However, these notifications do not include an identification of the user (e.g., any personally identifying information). The notifications may include metrics or other characteristics of the user that are not personally identifying, such as length of time that the user has interacted with the user interface corresponding to the location listing, length of time that the user visited the location, prequalification status 151, and so forth. The notifications may be sent by text message, phone call, a data feed in a web page, a social network system 118, email, or via other communications media.

The notifications may be sent based at least in part on selection criteria specified by the recipient or another user. For example, the first party's agent may designate that all of his or her notifications for one or more listings are to be copied to an associate who is a team member 178. The selection criteria may include thresholds for expression of interest (e.g., time spent looking at the listing or visiting), thresholds for prequalification status 151, and/or other selection criteria. Where a user receives several notifications via a data feed, the notifications may be ranked by various ranking criteria such as prequalification status 151, seriousness as expressed by levels of interest (e.g., length of engagement or quantity of engagements), asking price of the listing, recency, and/or other user-specified criteria.

In box 312, the location listing platform service 127 generates another one or more notifications to the user's agent (i.e., the second party agent 148), one or more team members 178 of the second party's agent, and/or one or more team members 145 of the user. Unlike the notifications of box 309, these notifications may include an identification of the user so that the second party's agent or others may personally follow up with the user. The notifications may include metrics or other characteristics of the user, such as visit length, engagement duration with the listing, and so forth. The notifications may be sent by text message, phone call, a data feed in a web page, a social network system 118, email, or via other communications media. The notifications may be triggered by a positive action taken by the user, e.g., selecting a user interface component labeled “notify my team about this listing.”

These notifications may be sent based at least in part on selection criteria specified by the recipient or another user and/or criteria specified by the second party. For example, the second party's agent may designate that all of his or her notifications for one or more second parties are to be copied to an associate who is a team member 178. The selection criteria may include thresholds for expression of interest (e.g., time spent looking at the listing or visiting), thresholds for prequalification status 151, and/or other selection criteria. Where a user receives several notifications via a data feed, the notifications may be ranked by various ranking criteria such as prequalification status 151, seriousness as expressed by levels of interest (e.g., length of engagement or quantity of engagements), asking price of the listing, recency, and/or other user-specified criteria.

In box 313, the location listing platform service 127 may generate one or more notifications to competing second parties of the location, one or more team members 145 of the competing second party, a competing second party's agent, and/or one or more team members 178 of the competing second party's agent. These notifications may include an identification of the second party agent 148 or indicate that the second party is unrepresented. However, these notifications do not include an identification of the user (e.g., any personally identifying information). The notifications may include metrics or other characteristics of the user that are not personally identifying, such as length of time that the user has interacted with the user interface corresponding to the location listing, length of time that the user visited the location, prequalification status 151, and so forth. The notifications may be sent by text message, phone call, a data feed in a web page, a social network system 118, email, or via other communications media.

The notifications may be sent based at least in part on selection criteria specified by the recipient or another user. For example, the competing second party's agent may designate that all of his or her notifications for one or more clients are to be copied to an associate who is a team member 178. The selection criteria may include thresholds for expression of interest (e.g., time spent looking at the listing or visiting), thresholds for prequalification status 151, and/or other selection criteria. Where a user receives several notifications via a data feed, the notifications may be ranked by various ranking criteria such as prequalification status 151, seriousness as expressed by levels of interest (e.g., length of engagement or quantity of engagements), asking price of the listing, recency, and/or other user-specified criteria. Thereafter, the operation of the portion of the location listing platform service 127 ends.

Turning now to FIG. 3B, shown is a flowchart that provides one example of the operation of another portion of the location listing platform service 127 according to various embodiments. It is understood that the flowchart of FIG. 3B provides merely an example of the many different types of functional arrangements that may be employed to implement the operation of the portion of the location listing platform service 127 as described herein. As an alternative, the flowchart of FIG. 3B may be viewed as depicting an example of elements of a method implemented in the computing environment 103 (FIG. 1) according to one or more embodiments.

Beginning with box 315, the location listing platform service 127 determines a list of friends of a user on a social network. For example, a user may have linked a social networking account with the location listing platform service 127, which may be stored in the social network data 160 or 175. The location listing platform service 127 may then request the list of friends via an application programming interface (API) call to one or more social network systems 118 via the network 121.

In box 318, the location listing platform service 127 determines a set of agents previously used by the circle of friends. For example, the agents may have been previously used as second party's agents to buy location or first party's agents to sell location. The set of agents may be filtered based upon recency among other factors.

In box 321, the location listing platform service 127 sends a recommendation of one or more agents to the user. The recommendation may be sent via the social network system 118, text message, email message, phone call, a notification or feed in a web page, or other approaches. The agent may be recommended based on a variety of factors such as, for example, the geographic location of the agent compared to the user, a promotional consideration provided by the agent, a popularity of the agent, a sales ranking of the agent, whether the agent responsive communications listing services, whether the agent responsive communications second party representation services, characteristics of agents that the user is looking for (either explicitly provided by the user or implicitly determined), and so on.

Although FIG. 3B describes referrals of agents, it is understood that the location listing platform service 127 may be similarly configured to provide social networking referrals for second parties, renters, and first party's clients. For instance, a potential second party or a potential first party may be referred to friends who hired local agents, and agents may be referred to friends of their clients. Thereafter, the operation of the portion of the location listing platform service 127 ends.

Continuing on to FIG. 3C, shown is a flowchart that provides one example of the operation of another portion of the location listing platform service 127 according to various embodiments. It is understood that the flowchart of FIG. 3C provides merely an example of the many different types of functional arrangements that may be employed to implement the operation of the portion of the location listing platform service 127 as described herein. As an alternative, the flowchart of FIG. 3C may be viewed as depicting an example of elements of a method implemented in the computing environment 103 (FIG. 1) according to one or more embodiments.

Beginning with box 324, the location listing platform service 127 receives search criteria 163 for a location listing search from a user at a second party client device 109 via the network 121. For example, the search criteria 163 may include average utility bill amount, asking price, size, geographic location, number of bedrooms and bathrooms, and so forth. In box 327, the location listing platform service 127 identifies a plurality of locations that match the search criteria 163. In some cases, the search criteria 163 may specify characteristics that the user does not like, e.g., having asbestos cement siding, synthetic stucco siding, aluminum wiring, or polybutylene plumbing. Thus, a location listing platform service 127 may receive an undesirable physical characteristic from the user through a user interface, and the location listing platform service 127 may identify the locations such that none of the locations embodies the undesirable physical characteristic.

In box 330, the location listing platform service 127 may rank the locations according to a match quality to the search criteria 163. Also, the location listing platform service 127 may rank the locations based at least in part on a comparison of characteristics of respective location to a set of locations in the data store 124 that the user (or a team member 145 of the user) has physically visited or engaged with a respective listing online. For example, the location listing platform service 127 may rank the locations based at least in part on a corresponding amount of time that the user has interacted with a corresponding user interface for a respective location. Also, the location listing platform service 127 may rank the locations based at least in part on a comparison of a respective asking value of a respective location to an amount of financing for which the user is qualified as indicated in the prequalification status 151. Also, the location listing platform service 127 may rank the listings according to a responsive communication deadline (i.e., a deadline by which all responsive communications must be submitted), and the responsive communication deadline may appear in the listing descriptions. In search results, listings with responsive communications may be ranked to appear at the top of the list.

In box 333, the location listing platform service 127 generates a user interface that renders a description of respective ones of the locations in a ranked order. To this end, the location listing platform service 127 may send data encoding the user interface via the network 121 to a browser or dedicated application executed on a second party client device 109. In box 336, the location listing platform service 127 determines a showing schedule 194 of one or more locations. Although FIG. 3C describes search as an access point for listing user interfaces, a data feed, location watchlists 166, and direct links may also be used as similar access points.

In box 339, the location listing platform service 127 indicates in the user interface whether the respective locations have one or more showings scheduled by other users, e.g., competing second parties. In some cases, the indication may exclude the exact time of the showing so as to avoid multiple competing second parties' computing devices being on location at the same time.

In box 342, the location listing platform service 127 includes a showing scheduling component in the user interface to schedule showings for one or more of the listed locations. The showing scheduling component is configured to facilitate scheduling a showing of the corresponding location at an allowable time. The allowable time may be determined based at least in part on an adjacency or proximity of previously scheduled showings of the location to one or more other users. For example, if another user has already scheduled a showing on Saturday at 2 pm, the location listing platform service 127 may recommend a time on Saturday afternoon near to the previously scheduled showing, such that the first party does not have to be absent from the location during disparate times.

Additionally, the allowable times may be determined based on contiguity and availability in the second party's agent's schedule. This allows consolidation of multiple location visits for a single second party, and also avoids booking a showing when the second party's agent is not available. In one embodiment, the showing scheduling component may be disabled for locations for which the amount of financing for which the user is prequalified is less than the asking price, or less than the asking price minus a predefined amount or proportion.

The user interface may also include a component configured to facilitate sending a responsive communication to buy or rent the corresponding location. If a responsive communication is already pending, the component may facilitate sending a backup offer. Activation of this component can cause a notification to be transmitted to the first party, team members 169, the first party's agent, and/or team members 178 of the first party's agent, along with information about the potential second party. This information may include prequalification status 151, visit length, number of visits, listing engagement metrics, and so forth. The offer may have a particular time open for acceptance. A subsequent user interface on the first party client device 112 may facilitate accepting the offer or countering. In some embodiments, the actions of making a responsive communication, countering, accepting, or declining may be moderated by the second party's agent or the first party's agent, such that the respective agents must approve the particular action. Thereafter, the operation of the portion of the location listing platform service 127 ends.

Transitioning to FIG. 3D, shown is a flowchart that provides one example of the operation of still another portion of the location listing platform service 127 according to various embodiments. It is understood that the flowchart of FIG. 3D provides merely an example of the many different types of functional arrangements that may be employed to implement the operation of the portion of the location listing platform service 127 as described herein. As an alternative, the flowchart of FIG. 3D may be viewed as depicting an example of elements of a method implemented in the computing environment 103 (FIG. 1) according to one or more embodiments.

Beginning with box 345, the location listing platform service 127 determines a location of a user mobile device (e.g., a second party client device 109) via a location-finding subsystem of the mobile device. For example, the second party client device 109 may be configured to periodically report its location to the location listing platform service 127 via the network 121 to facilitate geolocation of the device.

In box 348, the location listing platform service 127 determines that the location of the device matches a location or geofence of the location. That is, the user of the device is at the location. In some cases, the user may merely drive by the location, and this can be determined as well and credited as a visit or partial visit. In box 351, the location listing platform service 127 may generate one or more notifications to the offeror of the location (e.g., the first party or lessor), one or more team members 169 of the offeror of the location, a listing agent, and/or one or more team members 178 of the listing agent. These notifications include an identification of the second party agent 148 or indicate that the second party is unrepresented.

However, these notifications do not include an identification of the user (e.g., any personally identifying information). The notifications may include metrics or other characteristics of the user that are not personally identifying, such as length of time that the user has interacted with the user interface corresponding to the location listing, length of time that the user visited the location, prequalification status 151, and so forth. The notifications may be sent by text message, phone call, a data feed in a web page, a social network system 118, email, or via other communications media.

The notifications may be sent based at least in part on selection criteria specified by the recipient or another user. For example, the first party's agent may designate that all of his or her notifications for one or more listings are to be copied to an associate who is a team member 178. The selection criteria may include thresholds for expression of interest (e.g., time spent looking at the listing or visiting), thresholds for prequalification status 151, and/or other selection criteria. Where a user receives several notifications via a data feed, the notifications may be ranked by various ranking criteria such as prequalification status 151, seriousness as expressed by levels of interest (e.g., length of engagement or quantity of engagements), asking price of the listing, recency, and/or other user-specified criteria.

The notification may include a quantity of previous visits to the location by the user, as well as metrics detailing the user's engagement with the electronic location listing. In box 354, the location listing platform service 127 increments a record of the user's visits to the location in the physical visit history 154. In box 357, the location listing platform service 127 may add the location to the user's location watchlist 166.

Notifications may also be sent to the user's agent (i.e., the second party agent 148), one or more team members 178 of the second party's agent, and/or one or more team members 145 of the user. These notifications may include an identification of the user so that the second party's agent or others may personally follow up with the user. The notifications may include metrics or other characteristics of the user, such as visit length, engagement duration with the listing, and so forth. The notifications may be sent by text message, phone call, a data feed in a web page, a social network system 118, email, or via other communications media. The notifications may be triggered by a positive action taken by the user, e.g., selecting a user interface component labeled “notify my team about my visit.”

In box 360, the location listing platform service 127 determines that the user has exited the location. For example, the periodically reported location of the second party client device 109 may indicate a different location from the location. In box 363, the location listing platform service 127 may generate one or more notifications, which may be similar to those described relative to box 351 but prompted upon the user's leaving the location.

In box 366, the location listing platform service 127 may record the time spent by the user in visiting the location in the physical visit history 154 and/or the visit data 192. One or more notifications to the first party, first party's team members 169, the first party's agent 172, and/or the agent's team members 178 may include the length of the visit by the user and/or metrics across multiple users as to visit duration.

At a predefined time relative to a completion of the visit, a request for feedback about the location may be sent to the second party client device 109. If showing feedback is provided, the feedback is reviewable by the first party's team, including the first party, the first party's team members 169, the first party's agent, and the agent's team members 178. Thereafter, the operation of the portion of the location listing platform service 127 ends.

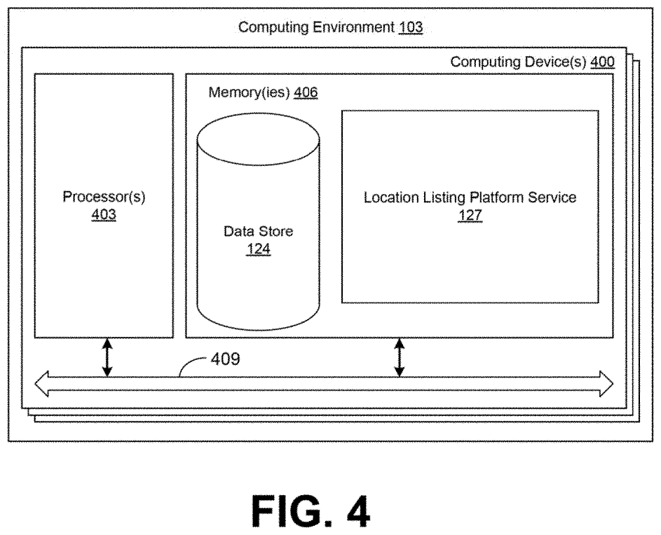

With reference to FIG. 4, shown is a schematic block diagram of the computing environment 103 according to an embodiment of the present disclosure. The computing environment 103 includes one or more computing devices 400. Each computing device 400 includes at least one processor circuit, for example, having a processor 403 and a memory 406, both of which are coupled to a local interface 409. To this end, each computing device 400 may comprise, for example, at least one server computer or like device. The local interface 409 may comprise, for example, a data bus with an accompanying address/control bus or other bus structure as can be appreciated.

Stored in the memory 406 are both data and several components that are executable by the processor 403. In particular, stored in the memory 406 and executable by the processor 403 are the location listing platform service 127 and potentially other applications. Also stored in the memory 406 may be a data store 124 and other data. In addition, an operating system may be stored in the memory 406 and executable by the processor 403.

It is understood that there may be other applications that are stored in the memory 406 and are executable by the processor 403 as can be appreciated. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

A number of software components are stored in the memory 406 and are executable by the processor 403. In this respect, the term “executable” means a program file that is in a form that can ultimately be run by the processor 403. Examples of executable programs may be, for example, a compiled program that can be translated into machine code in a format that can be loaded into a random access portion of the memory 406 and run by the processor 403, source code that may be expressed in proper format such as object code that is capable of being loaded into a random access portion of the memory 406 and executed by the processor 403, or source code that may be interpreted by another executable program to generate instructions in a random access portion of the memory 406 to be executed by the processor 403, etc. An executable program may be stored in any portion or component of the memory 406 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 406 is defined herein as including both volatile and nonvolatile memory and data storage components. Volatile components are those that do not retain data values upon loss of power. Nonvolatile components are those that retain data upon a loss of power. Thus, the memory 406 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 403 may represent multiple processors 403 and/or multiple processor cores and the memory 406 may represent multiple memories 406 that operate in parallel processing circuits, respectively. In such a case, the local interface 409 may be an appropriate network that facilitates communication between any two of the multiple processors 403, between any processor 403 and any of the memories 406, or between any two of the memories 406, etc. The local interface 409 may comprise additional systems designed to coordinate this communication, including, for example, performing load balancing. The processor 403 may be of electrical or of some other available construction.

Although the location listing platform service 127 and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts of FIGS. 3A-3D show the functionality and operation of an implementation of portions of the location listing platform service 127. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 403 in a computer system or other system. The machine code may be converted from the source code, etc. If embodied in hardware, each block may represent a circuit or a number of interconnected circuits to implement the specified logical function(s).

Although the flowcharts of FIGS. 3A-3D show a specific order of execution, it is understood that the order of execution may differ from that which is depicted. For example, the order of execution of two or more blocks may be scrambled relative to the order shown. Also, two or more blocks shown in succession in FIGS. 3A-3D may be executed concurrently or with partial concurrence. Further, in some embodiments, one or more of the blocks shown in FIGS. 3A-3D may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the location listing platform service 127, that comprises software or code can be embodied in any non-transitory computer-readable medium for use by or in connection with an instruction execution system such as, for example, a processor 403 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the location listing platform service 127, may be implemented and structured in a variety of ways. For example, one or more applications described may be implemented as modules or components of a single application. Further, one or more applications described herein may be executed in shared or separate computing devices or a combination thereof. For example, a plurality of the applications described herein may execute in the same computing device 400, or in multiple computing devices 400 in the same computing environment 103.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A non-transitory computer-readable medium embodying a program executable in at least one computing device, wherein when executed the program causes the at least one computing device to at least:
detecting a completion of a predefined action via a mobile device of a first user corresponding to a first potential second party, the predefined action comprising at least one of: an interaction with an electronic user interface corresponding to an electronic listing of a location for an interaction threshold, an addition of the electronic listing to a watchlist via the electronic user interface, a sharing action with respect to the electronic listing with one or more other users via an electronic network, or an automatic detection via a location-finding subsystem of the mobile device that the mobile device has physically visited the location based at least in part on a periodic reporting of a location of the mobile device by the location-finding subsystem via a network and determining whether the location of the mobile device matches a geofence of the location;
in response to detecting the completion of the predefined action via the mobile device:
automatically determine an agent associated with the first user;
automatically generate a first notification to a first computing device of an offeror of the location or to a second computing device of a listing agent of the location; and
automatically generate a second notification to a third computing device of a second user, corresponding to a second potential second party, that also has completed the predefined action or to a fourth computing device of an agent associated with the second user, the second user being unassociated with the first user, the second notification including a deadline for the second potential second party to respond to the second notification, the first notification and the second notification including an identification of the agent associated with the first user and excluding an identification of the first user;
receive a request for location information from the first user;
generate a user interface configured to render a description of the location, wherein the description of the location indicates whether at least one showing of the location to a third user is scheduled, whether at least one responsive communication for the location has been submitted by the third user, and a respective acceptance deadline for the at least one active responsive communication; and
send data encoding the user interface to the mobile device via the network.

2. The non-transitory computer-readable medium of claim 1, wherein when executed the program further causes the at least one computing device to at least:
generate a third notification to a fifth computing device of the agent associated with the first user or to another user associated with the first user, the third notification including the identification of the first user.

3. The non-transitory computer-readable medium of claim 1, wherein the first notification includes an amount of time that the first user has interacted with the electronic user interface corresponding to the electronic listing.

4. The non-transitory computer-readable medium of claim 1, wherein detecting the completion of the predefined action further comprises:
monitoring a location of the mobile device via the location-finding subsystem of the mobile device;
determining that the location of the mobile device corresponds to a location of the location; and
wherein the first notification includes an amount of time that the mobile device visited the location of the location.

5. The non-transitory computer-readable medium of claim 1, wherein when executed the program further causes the at least one computing device to at least:
determine a list of friends of the first user on a social network;
determine a set of agents previously used by one or more of the list of friends to obtain locations; and
send data encoding a recommendation of one or more of the set of agents to the mobile device.

6. A method, comprising:
determining that a mobile device of a first user corresponding to a first potential second party has physically visited a location via geolocation of the mobile device or that the mobile device received an interaction with an electronic user interface corresponding to an electronic listing of the location beyond a threshold time;
in response to determining that the mobile device has physically visited the location or that the mobile device has received the interaction with the electronic user interface beyond the threshold time:
automatically determining an agent associated with the first user;
automatically generating a first notification to a first computing device of an offeror of the location or to second computing device of a listing agent of the location; and
automatically generating a second notification to a third computing device of a second user, corresponding to a second potential second party, that also has completed a predefined action with respect to the location or to a fourth computing device an agent associated with the second user, the second user being unassociated with the first user, the first notification and the second notification including an identification of the agent associated with the first user and excluding an identification of the first user;
receiving a request for location information from the first user;
generating a user interface configured to render a description of the location, wherein the description of the location indicates whether at least one showing of the location to a third user is scheduled and whether at least one active responsive communication for the location has been submitted by the third user; and
sending data encoding the user interface to the mobile device via a network.

7. The method of claim 6, wherein the first notification includes a ranking associated with the first user indicating a level of interest of the first user as compared to the second user.

8. The method of claim 6, further comprising:
sending data encoding a request for feedback about the location to the mobile device at a predefined time relative to a completion of a visit of the mobile device to the location, the request for feedback including a responsive communication deadline; and
sending data encoding the responsive communication deadline to one or more of the first computing device, the second computing device, the third computing device, or the fourth computing device.

9. The method of claim 6, further comprising sending a third notification to a fifth computing device of the agent associated with the first user, the third notification identifying the location and the first user.

10. The method of claim 6, further comprising:
determining from an updated location of the mobile device that the mobile device has left the location; and
generating a third notification to the first computing device or to the second computing device indicating that the first user has left the location.

11. The method of claim 6, further comprising:
tracking a visit duration of the mobile device at the location via a location-finding subsystem of the mobile device; and
wherein the first notification includes the visit duration.

12. The method of claim 6, further comprising:
identifying a quantity of previous visits of the mobile device to the location from a data store; and
wherein the first notification indicates the quantity of previous visits.

13. A system, comprising:
at least one computing device; and
at least one application executable in the at least one computing device, wherein when executed the at least one application causes the at least one computing device to at least:
determine that a mobile device of a first user corresponding to a first potential second party has physically visited a location via geolocation of the mobile device associated with the first user or that the mobile device has detected an interaction with an electronic user interface corresponding to an electronic listing of the location beyond a threshold time;
in response to determining that the mobile device has physically visited the location or that the mobile device has detected the interaction with the electronic user interface beyond the threshold time:
automatically determine an agent associated with the first user;
automatically generate a first notification to a first computing device of an offeror of the location or to a second computing device of a listing agent of the location; and
automatically generate a second notification to a third computing device of a second user, corresponding to a second potential second party, that also has completed a predefined action with respect to the location or to a fourth computing device of an agent associated with the second user, the second user being unassociated with the first user, the first notification and the second notification including an identification of the agent associated with the first user and excluding an identification of the first user;
receive a request for location information from the first user;
generate a user interface configured to render a description of the location, wherein the description of the location indicates whether at least one showing of the location to a third user is scheduled and whether at least one active responsive communication for the location has been submitted by the third user; and
send data encoding the user interface to the mobile device via a network.

14. The method of claim 6, wherein the first notification includes a ranking associated with the first user indicating a level of interest of the first user as compared to the second user.

15. The system of claim 13, wherein when executed the at least one application further causes the at least one computing device to at least send a request for feedback about the location to the mobile device at a predefined time relative to a completion of a visit of the mobile device to the location.

16. The system of claim 13, wherein when executed the at least one application further causes the at least one computing device to at least send a third notification to a fifth computing device of the agent associated with the first user, the third notification identifying the location and the first user.

17. The system of claim 13, wherein when executed the at least one application further causes the at least one computing device to at least:
determine from an updated location of the mobile device that the mobile device has left the location; and
generate a third notification to the first computing device or to the second computing device indicating that the first user has left the location.

18. The system of claim 13, wherein when executed the at least one application further causes the at least one computing device to at least:
track a visit duration of the mobile device at the location via a location-finding subsystem of the mobile device; and
wherein the first notification includes the visit duration.

19. The system of claim 13, wherein when executed the at least one application further causes the at least one computing device to at least:
identify a quantity of previous visits of the mobile device to the location from a data store; and
wherein the first notification indicates the quantity of previous visits.

20. The system of claim 13, further comprising tracking which of a plurality of portions of the location have been visited by the mobile device based at least in part on data provided by a location-finding subsystem of the mobile device.
